(19) United States
(12) Patent Application Publication
(10) Pub. No.: US 2020/0246872 A1
(43) Pub. Date: Aug. 6, 2020

(54) THREE-DIMENSIONAL LAMINATING AND SHAPING APPARATUS, CONTROL METHOD OF THREE-DIMENSIONAL LAMINATING AND SHAPING APPARATUS, AND CONTROL PROGRAM OF THREE-DIMENSIONAL LAMINATING AND SHAPING APPARATUS

(71) Applicant: KANTATSU CO., LTD., Yaita-shi (JP)

(72) Inventor: Eiji OSHIMA, Yaita-shi (JP)

(21) Appl. No.: 16/664,591

(22) Filed: Oct. 25, 2019

(30) Foreign Application Priority Data
Oct. 26, 2018 (JP) 2018-201377

(51) Int. Cl. B22F 3/105

(52) U.S. Cl. CPC B22F 3/1055; B22F 2003/1057; B22F 2202/11; B33Y 30/00; B22F 2301/15; B22F 2301/205; B22F 2301/052; B22F 2301/10

(57) ABSTRACT

A metal laminated and shaped object is shaped by optical shaping. A three-dimensional laminating and shaping apparatus includes a shaping stage as a place where a metal laminated and shaped object is shaped, a moving unit that moves the shaping stage, a supplier that supplies metal powder particles in a layer on a surface of the shaping stage, and a light irradiator that irradiates, with a laser beam, powder particles at a predetermined position among the powder particles supplied in the layer on the surface of the shaping stages. The light irradiator includes a laser diode that emits the laser beam, and an electromechanical mirror that reflects the laser beam and irradiates, with the laser beam, the metal powder particles at the predetermined position among the metal powder particles supplied in the layer on the surface of the shaping stage. The supplier supplies metal powder particles having a particle size of not more than 50 μm. The moving unit moves the shaping stage by one layer in a direction away from the light irradiator in accordance with the particle size.

### BACKGROUND OF THE INVENTION

### Field of the Invention

The present invention relates to a three-dimensional laminating and shaping apparatus, a control method of the three-dimensional laminating and shaping apparatus, and a control program of the three-dimensional laminating and shaping apparatus.

### Description of the Related Art

In the above technical field, patent literature 1 discloses a three-dimensional laminating and shaping apparatus that irradiates metal powder particles with a charged particle beam.

[Patent Literature 1] Japanese Patent Laid-Open No. 2015-193866

### SUMMARY OF THE INVENTION

In the technique described in the above literature, however, it is impossible to shape a metal laminated and shaped object by optical shaping.

The present invention provides a technique of solving the above-described problem.

One example aspect of the present invention provides a three-dimensional laminating and shaping apparatus comprising:

a shaping stage as a place where a metal laminated and shaped object is shaped;

a moving unit that moves the shaping stage;

a supplier that supplies metal powder particles in a layer on a surface of the shaping stage; and

a light irradiator that irradiates, with a laser beam, powder particles at a predetermined position among the metal powder particles supplied in the layer on the surface of the shaping stages,

the light irradiator including

a laser diode that emits the laser beam, and

an electromechanical mirror that reflects the laser beam and irradiates, with the laser beam, the metal powder particles at the predetermined position among the metal powder particles supplied in the layer on the surface of the shaping stage,

wherein the supplier supplies metal powder particles having a particle size of not more than 50 μm, and

the moving unit moves the shaping stage by one layer in a direction away from the light irradiator in accordance with the particle size.

Another example aspect of the present invention provides a control method of a three-dimensional laminating and shaping apparatus including

a shaping stage as a place where a metal laminated and shaped object is shaped,

a moving unit that moves the shaping stage,

a supplier that supplies metal powder particles in a layer on a surface of the shaping stage, and

a light irradiator that irradiates, with a laser beam, powder particles at a predetermined position among the metal powder particles supplied in the layer on the surface of the shaping stages,

the light irradiator including

a laser diode that emits the laser beam, and

an electromechanical mirror that reflects the laser beam and irradiates, with the laser beam, the metal powder particles at the predetermined position among the metal powder particles supplied in the layer on the surface of the shaping stage,

the method comprising:

causing the supplier to supply metal powder particles having a particle size of not more than 50 μm; and

causing the moving unit to move the shaping stage by one layer in a direction away from the light irradiator in accordance with the particle size.

Still other example aspect of the present invention provides a control program of a three-dimensional laminating and shaping apparatus including

a shaping stage as a place where a metal laminated and shaped object is shaped,

a moving unit that moves the shaping stage,

a supplier that supplies metal powder particles in a layer on a surface of the shaping stage, and

a light irradiator that irradiates, with a laser beam, powder particles at a predetermined position among the metal powder particles supplied in the layer on the surface of the shaping stages,

the light irradiator including

a laser diode that emits the laser beam, and

an electromechanical mirror that reflects the laser beam and irradiates, with the laser beam, the metal powder particles at the predetermined position among the metal powder particles supplied in the layer on the surface of the shaping stage,

the program for causing a computer to execute a method, comprising:

causing the supplier to supply metal powder particles having a particle size of not more than 50 μm; and

causing the moving unit to move the shaping stage by one layer in a direction away from the light irradiator in accordance with the particle size.

According to the present invention, it is possible to shape a metal laminated and shaped object by optical shaping.

### BRIEF DESCRIPTION OF THE DRAWINGS

FIG. 1 is a view for explaining the arrangement of a three-dimensional laminating and shaping apparatus according to the first example embodiment of the present invention;

FIG. 2 is a view for explaining the arrangement of a three-dimensional laminating and shaping apparatus according to the second example embodiment of the present invention;

FIG. 3 is a view for explaining an example of the arrangement of a light irradiator of the three-dimensional laminating and shaping apparatus according to the second example embodiment of the present invention;

FIG. 4 is a table for explaining an example of a shaping table provided in the three-dimensional laminating and shaping apparatus according to the second example embodiment of the present invention;

FIG. 5 is a block diagram showing the hardware arrangement of the three-dimensional laminating and shaping apparatus according to the second example embodiment of the present invention;

FIG. 6 is a flowchart for explaining the operation procedure of the three-dimensional laminating and shaping apparatus according to the second example embodiment of the present invention;

FIG. 7A is a schematic front view for explaining a three-dimensional laminating and shaping apparatus according to the third example embodiment of the present invention; and

FIG. 7B is a schematic front view for explaining the three-dimensional laminating and shaping apparatus according to the third example embodiment of the present invention.

### DESCRIPTION OF THE EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

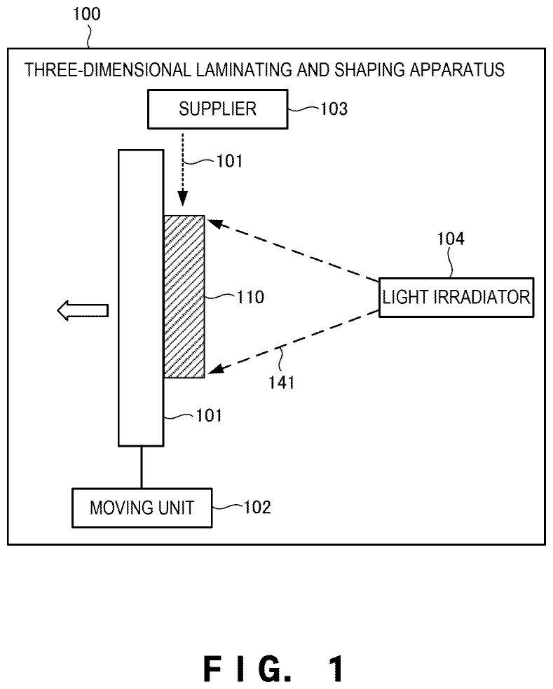

A three-dimensional laminating and shaping apparatus 100 according to the first example embodiment of the present invention will be described with reference to FIG. 1. FIG. 1 is a view for explaining the arrangement of the three-dimensional laminating and shaping apparatus according to this example embodiment. The three-dimensional laminating and shaping apparatus 100 is an apparatus that shapes a metal laminated and shaped object by optical shaping. As shown in FIG. 1, the three-dimensional laminating and shaping apparatus 100 includes a shaping stage 101, a moving unit 102, a supplier 103, and a light irradiator 104.

The shaping stage 101 is a place where a metal laminated and shaped object is shaped. The moving unit 102 moves the shaping stage 101. The supplier 103 supplies metal powder particles in a layer on the surface of the shaping stage 101. The light irradiator 104 irradiates powder particles at a predetermined position among the powder particles supplied in the layer on the surface of the shaping stage 101. The light irradiator 104 includes a laser diode that emits a laser beam, and an electromechanical mirror that reflects the laser beam and irradiates, with the laser beam, the metal powder particles at the predetermined position among the metal powder particles supplied in the layer on the surface of the shaping stage 101. The supplier 103 supplies metal powder particles having a particle size of 50 μm or less. The moving unit 102 moves the shaping stage 101 by one layer in a direction away from the light irradiator 104 in accordance with the particle size.

According to this example embodiment, it is possible to shape a metal laminated and shaped object by optical shaping.

### Second Example Embodiment

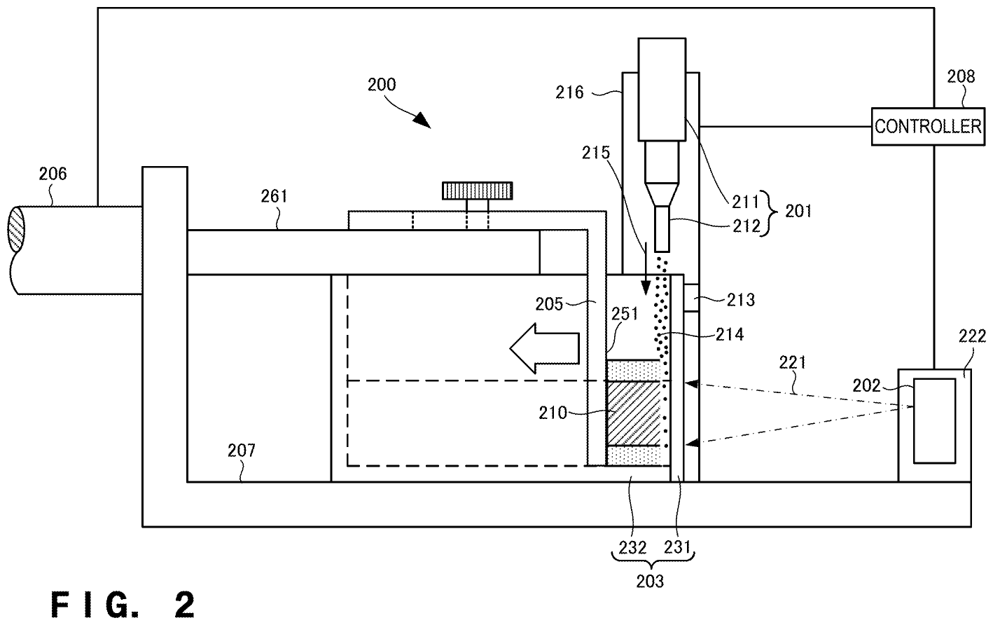

A three-dimensional laminating and shaping apparatus according to the second example embodiment of the present invention will be described next with reference to FIGS. 2 to 6. FIG. 2 is a view for explaining the arrangement of the three-dimensional laminating and shaping apparatus according to this example embodiment. A three-dimensional laminating and shaping apparatus 200 includes a supplier 201, a light irradiator 202, a shaping tank 203, a shaping stage 205, a driver 206, a base plate 207, and a controller 208. Note that a metal laminated and shaped object 210 is a three-dimensional shaped object shaped from metal powder particles 214.

The supplier 201 drops the metal powder particles 214 for shaping the metal laminated and shaped object 210 to supply them to the shaping tank 203, and is also called a dispenser. The supplier 201 includes a powder storage 211 and a nozzle 212. The powder storage 211 temporarily stores the metal powder particles 214 for shaping the metal laminated and shaped object 210, and is also called a hopper. The metal powder particles 214 stored in the powder storage 211 contain at least one of copper, nickel, cobalt, molybdenum, titanium, aluminum, and stainless, but the present invention is not limited to them. The particle size of the metal powder particles 214 is 50 μm or less and more preferably 2.0 μm or less.

The metal powder particles 214 stored in the powder storage 211 are supplied from the nozzle 212 at the distal end of the supplier 201. The metal powder particles 214 released from the nozzle 212 reach the shaping tank 203 by free fall (gravity). That is, the supplier 201 supplies the metal powder particles 214 into the shaping tank 203 by dropping the metal powder particles 214. Note that the metal powder particles 214 supplied from the supplier 201 can also be released by being pushed by an air pressure or the like. The supplier 201 thus recoats the metal powder particles 214.

A supply amount sensor 213 detects the amount of the metal powder particles 214 supplied into the shaping tank 203. The supply amount sensor 213 is, for example, an ultrasonic sensor or an infrared sensor. For example, when the metal powder particles 214 supplied into the shaping tank 203 reach a position (height) at which the supply amount sensor 213 is attached, the supply amount sensor 213 detects the metal powder particles 214, so it is possible to detect that the amount of the metal powder particles 214 reaches a predetermined amount. The supply amount sensor 213 is arranged near the distal end of the nozzle 212 of the supplier 201.

The light irradiator 202 is placed on a base 222, and irradiates the metal powder particles 214 accommodated in the shaping tank 203 with a laser beam 221 from outside the shaping tank 203.

The shaping tank 203 is a rectangular parallelepiped (box-like) tank in which the metal laminated and shaped object 210 is shaped. The shaping tank 203 has an opening in a surface on the side of the supplier 201. The shaping tank 203 is arranged in a position below the supplier 201. The metal powder particles 214 supplied from the supplier 201 reach the shaping tank 203 through the opening of the shaping tank 203. Note that the shape of the shaping tank 203 is not limited to a rectangular parallelepiped shape and may also be a cubic shape or another shape.

The shaping tank 203 includes a tank cover 231 and a tank case 232. The tank cover 231 is a side portion (wall portion) of the shaping tank 203. The tank cover 231 is a member (laser beam transmitting member) such as glass, plastic, or a resin which transmits the light beam 221. However, the member is not limited to these materials as long as the member can transmit the laser beam 221.

The shaping stage 205 is a platform on which the metal laminated and shaped object 210 is shaped, and is accommodated in the shaping tank 203. The shaping stage 205 has a surface 251 as the base of the metal laminated and shaped object 210. That is, the metal laminated and shaped object 210 is shaped on the surface 251 of the shaping stage 205. The shaping stage 205 is provided such that the surface 251 is parallel to a falling direction 215 of the metal powder particles 214 or the vertical direction. That is, the surface 251 is a surface parallel to the vertical direction. That is, the shaping stage 205 stands vertically on the bottom surface of the tank case 232.

Therefore, the metal laminated and shaped object 210 to be shaped on the surface 251 is laminated in a direction (lateral direction) perpendicular to the vertical direction. Note that the surface 251 is not limited to the surface parallel to the vertical direction. For example, a surface that forms an angle of 45° or less with respect to the vertical direction is preferable but a surface that forms an angle of 45° or more may be possible. The metal powder particles 214 for shaping the metal laminated and shaped object 210 are supplied to the gap between the shaping stage 205 and the tank cover 231 on the side of the shaping tank 203, on which the light irradiator 202 is installed.

That is, the supplier 201 supplies the metal powder particles 214 to the gap between the surface 251 and the inner wall surface of the shaping tank 203. That is, the supplier 201 supplies the metal powder particles 214 to the gap between the surface 251 of the shaping stage 205 and the inner wall surface of the shaping tank 203 on the side of the light irradiator 202 (the inner wall surface of the tank cover 231). For example, the amount of the metal powder particles 214 to be supplied from the supplier 201 is adjusted in accordance with the distance between the tank cover 231 and the shaping stage 205. In addition, the thickness of one layer of the metal laminated and shaped object 210 is determined by the distance between the tank cover 231 and the shaping stage 205. The thickness (laminating interval or laminating pitch) of one layer of the metal laminated and shaped object 210 is determined in accordance with the particle size of the metal powder particles 214. That is, the thickness of one layer of the metal laminated and shaped object 210 is larger than the particle size of the metal powder particles 214. If, for example, the particle size of the supplied metal powder particles 214 is 2.0 μm, the thickness of one layer of the metal laminated and shaped object 210 is larger than 2.0 μm.

When the metal powder particles 214 are supplied in this way, the supplied metal powder particles 214 form a layer having a uniform thickness, and it is unnecessary to perform an operation (so-called squeegee) for leveling the supplied metal powder particles 214 unlike the conventional technique. That is, if the metal powder particles 214 having a particle size of 2.0 μm or less is horizontally laminated like the conventional technique, the leveling operation crushes the metal powder particles 214, thereby degrading quality as the shaping material of the metal laminated and shaped object. To the contrary, since the three-dimensional laminating and shaping apparatus 200 need not level the supplied metal powder particles 214, the problem that the quality of the metal powder particles 214 degrades does not arise. Furthermore, a layer of the metal powder particles 214 having a uniform thickness can be formed by only supplying the metal powder particles 214 without performing an operation of leveling the supplied metal powder particles 214.

The light irradiator 202 irradiates, with the laser beam 221, the metal powder particles 214 of one layer, which are supplied between the tank cover 231 (the inner wall surface of the shaping tank 203) and the surface 251 and accommodated between them. The metal powder particles 214 irradiated with the laser beam 221 melt and solidify. The metal powder particles 214 not irradiated with the laser beam 221 do not solidify. When the supply and solidification of the metal powder particles 214 of one layer are complete, the three-dimensional laminating and shaping apparatus 200 performs the supply and solidification of the metal powder particles 214 of the next one layer. The three-dimensional laminating and shaping apparatus 200 shapes the metal laminated and shaped object 210 by repeating this process.

A linear driver unit is extended from the driver 206, and is connected to the shaping stage 205. The driver 206 is a driving mechanism including an actuator or a motor. When the driver 206 is driven, a linear driver unit 261 moves. In synchronism with the movement of the linear driver unit 261, the shaping stage 205 also moves in the direction (the direction of an arrow) perpendicular to the surface 251. The distance between the tank cover 231 and the shaping stage 205 is adjusted by driving the driver 206.

Note that after the supply of the metal powder particles 214, the driver 206 may press the shaping stage 205 toward the tank cover 231 (a direction opposite to the arrow in FIG. 2). In this case, the driver 206 moves the shaping stage 205 to the inner wall surface side after the supplier 201 supplies the metal powder particles 214 to the gap between the inner wall surface of the shaping tank 203 and the surface 251 of the shaping stage 205 before the light irradiator 202 irradiates the metal powder particles 214 with the laser beam 221. This can form the supplied metal powder particles 214 into a layer having a uniform thickness without performing an operation of leveling the supplied metal powder particles 214, and can also increase the bulk density of the metal powder particles 214.

The light irradiator 202 and the shaping tank 203 are placed on the base plate 207. Note that the supplier 201 is attached to the base plate 207 by using an installation plate 216. The light irradiator 202 is attached to the base 222 installed on the upper surface of the base plate 207. The light irradiator 202 irradiates the shaping tank 203 with a laser beam.

The shaping tank 203 is thus arranged in the lateral direction (the direction horizontal to the placement surface of the base plate 207) of the light irradiator 202. Accordingly, the three-dimensional laminating and shaping apparatus 200 can manufacture the metal laminated and shaped object 210 by lamination in the lateral direction.

The controller 208 receives a detection result detected by the supply amount sensor 213. In accordance with the detection result obtained by the supply amount sensor 213, the controller 208 controls the supplier 201, the light irradiator 202, and the driver 206. The controller 208 controls the supply amount and supply timing of the metal powder particles 214 supplied by the supplier 201. The controller 208 also controls the irradiation intensity and irradiation time of the laser beam 221 emitted by the light irradiator 202. Furthermore, the controller 208 controls the moving amount and moving timing of the shaping stage 205 moved by the driver 206.

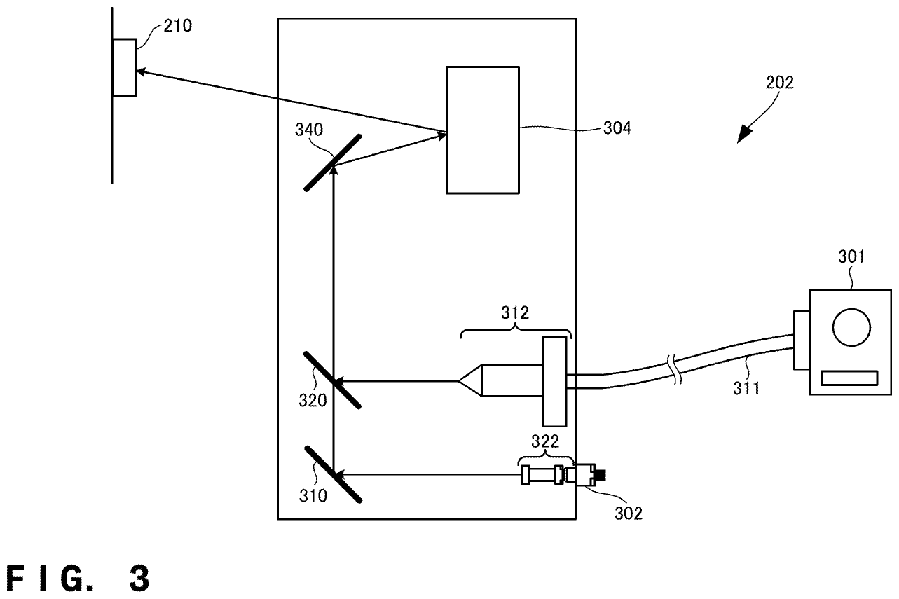

FIG. 3 is a view for explaining an example of the arrangement of the light irradiator of the three-dimensional laminating and shaping apparatus according to this example embodiment. The light irradiator 202 includes a light source 301, a laser source 302, and a two-dimensional MEMS (Micro Electro Mechanical System) mirror 304. The two-dimensional MEMS mirror is an electromechanical mirror.

The light source 301 serves as an oscillator of a solid-state laser, a gas laser, or a high-power semiconductor laser. A laser beam emitted from the light source 301 is guided to a condenser 312 through an optical fiber 311 that guides a laser beam. The condenser 312 includes a condenser lens and a collimator lens. For example, a laser beam entering the condenser 312 is condensed by the condenser lens, is collimated by the collimator lens, and is then emitted.

The laser source 302 is a light source of a laser beam. A laser beam emitted from the laser source 302 is guided to a condenser 322. The condenser 322 includes a condenser lens and a collimator lens. The laser source 302 is a semiconductor LD (Laser Diode), and is a laser beam oscillation element that emits (oscillates) a visible laser beam or the like. For example, a visible laser beam entering the condenser 322 is condensed by the condenser lens, is collimated by the collimator lens, and is then emitted. Note that the laser beam emitted from the light source 301 may be positioned using the laser beam emitted from the laser source 302.

An output of the laser beam emitted from each of the light source 301 and the laser source 302 is, for example, 100 W. However, the output is not limited to this, and may be less or more than 100 W.

The two-dimensional MEMS mirror 304 is a driving mirror that is driven based on a control signal input from the outside, and vibrates to reflect the laser beam while changing the angle in the horizontal direction (X direction) and the vertical direction (Y direction). The laser beam reflected by the two-dimensional MEMS mirror 304 is corrected by a view angle correction element (not shown) in terms of a view angle. Then, the laser beam which has been corrected in terms of the view angle is scanned on the metal laminated and shaped object 210 or a process surface, thereby performing desired processing or shaping. Note that the view angle correction element is installed, as needed. Note that two one-dimensional MEMS mirrors may be used, instead of using the two-dimensional MEMS mirror 304.

The laser beam emitted from the light source 301 is reflected by mirrors 320 and 340 to reach the two-dimensional MEMS mirror 304. Similarly, the laser beam emitted from the laser source 302 is reflected by a mirror 310 and the mirror 340 to reach the two-dimensional MEMS mirror 304. The mirror 340 is arranged in a bottom portion (bottom surface) of the light irradiator 202. The mirror 310 reflects the reflected light of the laser beam from the laser source 302 downward to the mirror 340 arranged on the bottom surface. The mirror 320 reflects the reflected light of the laser beam from the light source 301 downward to the mirror 340 arranged on the bottom surface. The mirror 340 reflects the laser beam from each of the mirrors 310 and 320 upward to the two-dimensional MEMS mirror 304 arranged above the mirror 340. The two-dimensional MEMS mirror 304 scans the reflected light from the mirror 340 in the two-dimensional directions to perform irradiation.

Each of the laser beams emitted from the light source 301 and the laser source 302 is reflected by the mirror 310 or 320, and passes through the two-dimensional MEMS mirror 304, thereby reaching the metal laminated and shaped object 210. That is, the laser beam emitted from the light source 301 and that emitted from the laser source 302 pass through the same optical path. Therefore, if positioning is performed using the laser beam from the laser source 302, a position which is irradiated with the laser beam from the laser source 302 is irradiated with the laser beam from the light source 301, and thus positioning of the laser beam from the light source 301 can be readily performed.

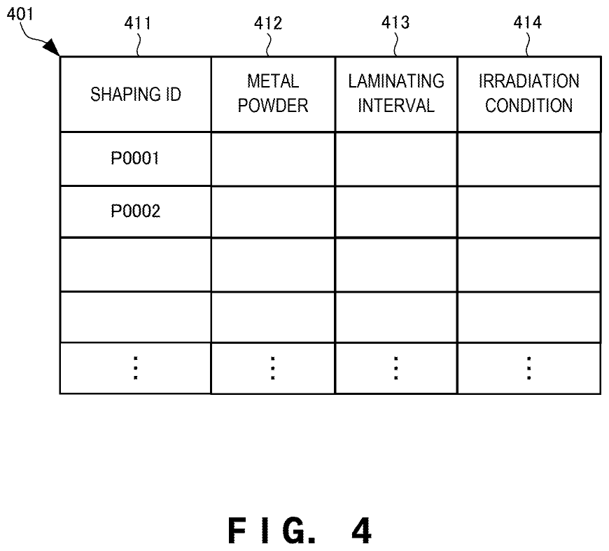

FIG. 4 is a table for explaining an example of a shaping table provided in the three-dimensional laminating and shaping apparatus according to this example embodiment. A shaping table 401 stores a metal powder 412, a laminating interval 413, and an irradiation condition 414 in association with a shaping ID (IDentifier) 411. The shaping ID 411 is an identifier for identifying shaping of the metal laminated and shaped object 210 by the three-dimensional laminating and shaping apparatus 200. The metal powder 412 is data of metal powder particles to be used for shaping, and includes data of the kind of metal, the particle size of the powder particles, and the like. The laminating interval 413 indicates the thickness of one layer of the metal laminated and shaped object 210 when laminating and shaping the metal laminated and shaped object 210, and represents an amount by which the shaping stage 205 is slid, that is, a laminating pitch. The irradiation condition 414 indicates the irradiation condition of a laser beam, and includes the frequency, output, irradiation time, scanning pitch (scanning interval), and scanning width of the laser beam. The three-dimensional laminating and shaping apparatus 200 shapes the metal laminated and shaped object 210 with reference to, for example, the shaping table 401.

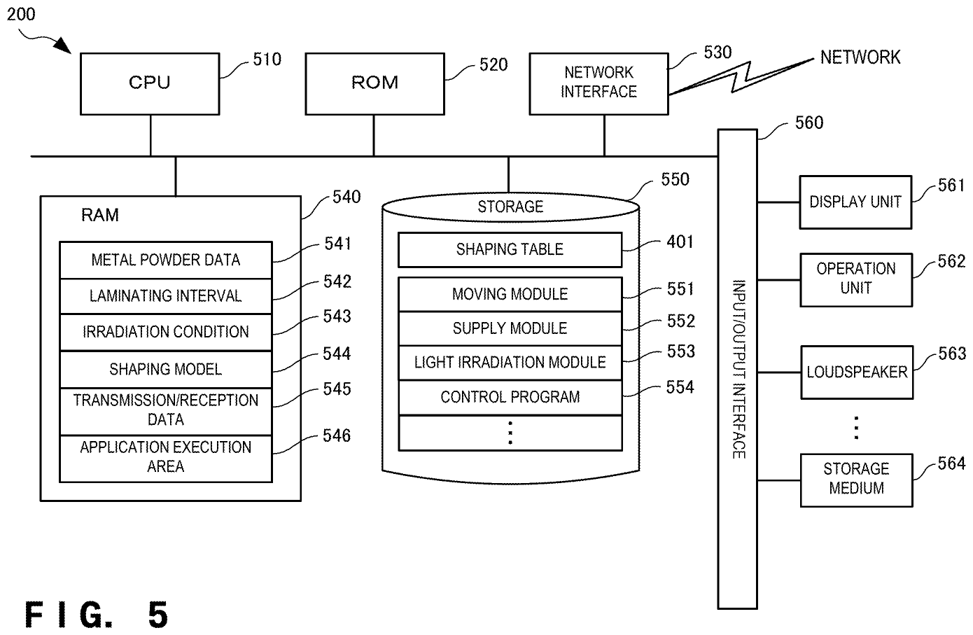

FIG. 5 is a block diagram showing the hardware arrangement of the three-dimensional laminating and shaping apparatus according to this example embodiment. A CPU (Central Processing Unit) 510 is an arithmetic control processor, and implements the functional components of the three-dimensional laminating and shaping apparatus 200 shown in FIG. 2 by executing a program. The CPU 510 may include a plurality of processors to parallelly execute different programs, modules, tasks, or threads. A ROM (Read Only Memory) 520 stores permanent data such as initial data and a program, and other programs. A network interface 530 communicates with another apparatus via a network. Note that the number of CPUs 510 is not limited to one, and a plurality of CPUs or a GPU (Graphics Processing Unit) for image processing may be included. The network interface 530 desirably includes a CPU independent of the CPU 510, and writes or reads out transmission/reception data in or from the area of a RAM (Random Access Memory) 540. It is desirable to provide a DMAC (Direct Memory Access Controller) (not shown) for transferring data between the RAM 540 and a storage 550. Furthermore, the CPU 510 processes the data by recognizing that the data has been received by or transferred to the RAM 540. The CPU 510 prepares a processing result in the RAM 540, and delegates succeeding transmission or transfer to the network interface 530 or DMAC.

The RAM 540 is a random access memory used as a temporary storage work area by the CPU 510. An area to store data necessary for implementation of this example embodiment is allocated to the RAM 540. Metal powder data 541 is data concerning metal powder particles used to shape the metal laminated and shaped object 210. A laminating interval 542 indicates the thickness (laminating pitch) of one layer of the metal laminated and shaped object 210 in shaping of the metal laminated and shaped object 210. An irradiation condition 543 is data indicating the output, the irradiation time, and the like of a laser beam used to shape the metal laminated and shaped object 210. A shaping model 544 is CAD (Computer Aided Design) data used to shape the metal laminated and shaped object 210. The three-dimensional laminating and shaping apparatus 200 shapes the metal laminated and shaped object based on this data. These data are deployed from, for example, the shaping table 401.

Transmission/reception data 545 is data transmitted/received via the network interface 530. The RAM 540 includes an application execution area 546 for executing various application modules.

The storage 550 stores a database, various parameters, or the following data or programs necessary for implementation of this example embodiment. The storage 550 stores the shaping table 401. The shaping table 401 is the table, shown in FIG. 4, for managing the relationship between the shaping ID 411 and the irradiation condition 414 and the like.

The storage 550 also stores a moving module 551, a supply module 552, and a light irradiation module 553. The moving module 551 is a module that moves the shaping stage 205 in the laminating direction. The supply module 552 is a module that supplies the metal powder particles 214 in a layer on the surface 251 of the shaping stage 205. The light irradiation module 553 is a module that irradiate, with the laser beam 221, metal powder particles at a predetermined position among the metal powder particles supplied in the layer on the surface 251 of the shaping stage 205. These modules 551 to 553 are read out by the CPU 510 into the application execution area 546 of the RAM 540, and executed. A control program 554 is a program for controlling the whole three-dimensional laminating and shaping apparatus 200.

An input/output interface 560 interfaces input/output data with an input/output device. The input/output interface 560 is connected to a display unit 561 and an operation unit 562. In addition, a storage medium 564 may be connected to the input/output interface 560. A loudspeaker 563 serving as a voice output unit, a microphone (not shown) serving as a voice input unit, or a GPS position determiner may also be connected. Note that programs and data which are associated with the general-purpose functions of the three-dimensional laminating and shaping apparatus 200 and other feasible functions are not shown in the RAM 540 or the storage 550 of FIG. 5.

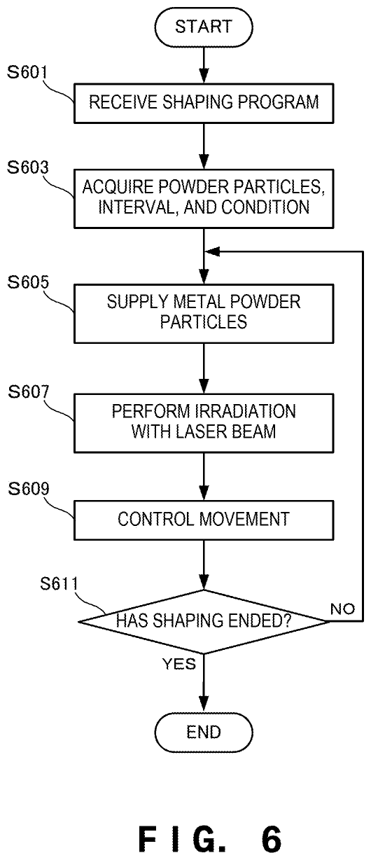

FIG. 6 is a flowchart for explaining the operation procedure of the three-dimensional laminating and shaping apparatus according to this example embodiment. This flowchart is executed by the CPU 510 of FIG. 5 using the RAM 540, thereby implementing the functional components of the three-dimensional laminating and shaping apparatus 200 shown in FIG. 2. In step S601, the three-dimensional laminating and shaping apparatus 200 receives a shaping program. In step S603, the three-dimensional laminating and shaping apparatus 200 acquires the kind and particle size of the metal powder particles to be used to shape the metal laminated and shaped object 210. The three-dimensional laminating and shaping apparatus 200 also acquires the laminating interval and the irradiation condition of a laser beam.

In step S605, the three-dimensional laminating and shaping apparatus 200 supplies the metal powder particles 214. In step S607, the three-dimensional laminating and shaping apparatus 200 irradiates the supplied metal powder particles 214 with the laser beam 221. In step S609, the three-dimensional laminating and shaping apparatus 200 controls the shaping stage 205 to slide and move in accordance with the laminating interval. In step S611, the three-dimensional laminating and shaping apparatus 200 determines whether shaping of the metal laminated and shaped object 210 has ended. If shaping of the metal laminated and shaped object 210 has not ended (NO in step S611), the three-dimensional laminating and shaping apparatus 200 returns to step S605 to repeat the subsequent steps; otherwise (YES in step S611), the three-dimensional laminating and shaping apparatus 200 ends the shaping processing.

According to this example embodiment, a metal laminated and shaped object can be shaped by optical shaping. Since the MEMS mirror is used as a light irradiator, a high-power laser beam can be emitted with a simple arrangement. Then, since a high-power laser beam can be emitted, an apparatus having a simple arrangement can shape a metal laminated and shaped object. Furthermore, since the laminating interval of one layer of a metal laminated and shaped object is made small, it is possible to shape the metal laminated and shaped object even by a laser beam. In addition, since a metal laminated and shaped object is shaped by lamination in the lateral direction, even if the metal powder particles have a small particle size, it is unnecessary to level the supplied metal powder particles unlike lamination in the longitudinal direction (vertical direction). Thus, a metal laminated and shaped object can be shaped reliably even by metal powder particles having a small particle size. Similarly, since the laminating interval is made small to reduce the thickness of one layer of a metal laminated and shaped object, it is possible to shape the metal laminated and shaped object even by a laser beam.

### Third Example Embodiment

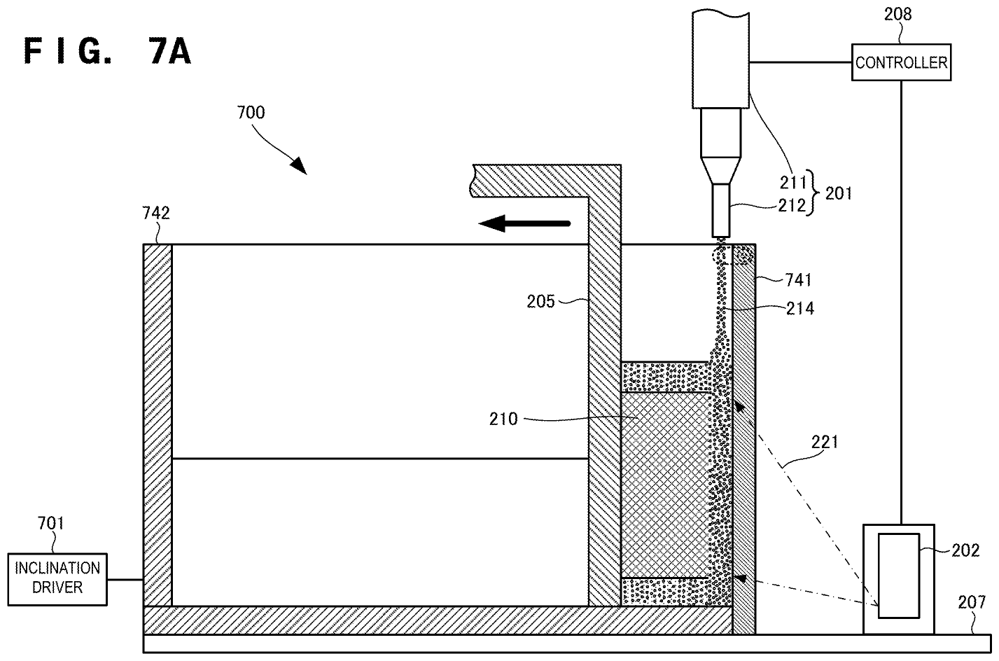

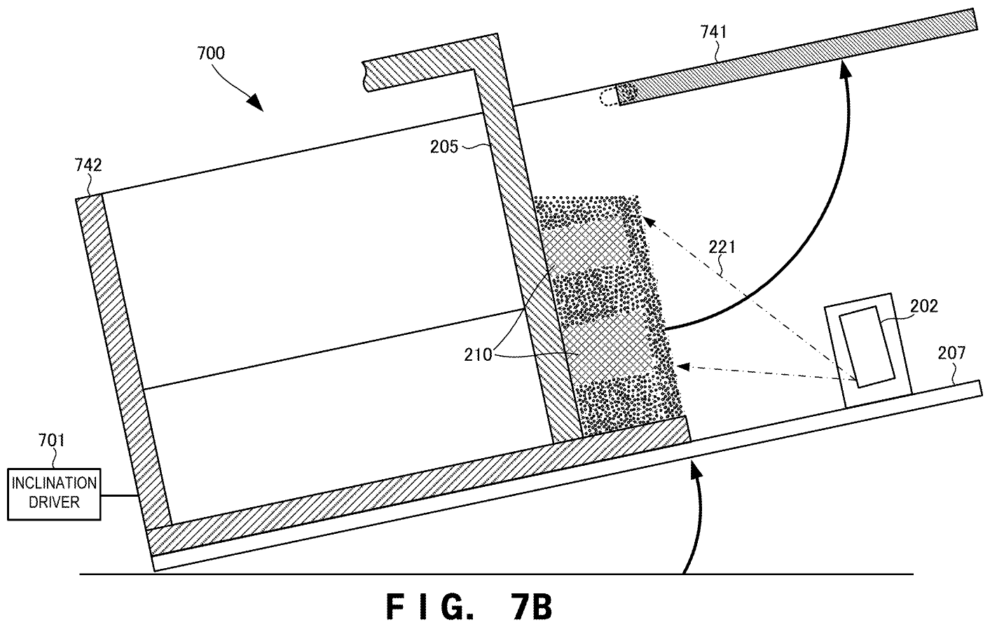

A three-dimensional laminating and shaping apparatus according to the third example embodiment of the present invention will be described next with reference to FIGS. 7A and 7B. FIG. 7A is a schematic front view for explaining the arrangement of the three-dimensional laminating and shaping apparatus according to this example embodiment. FIG. 7B is a schematic front view for explaining a state in which the three-dimensional laminating and shaping apparatus according to this example embodiment is inclined. The three-dimensional laminating and shaping apparatus according to this example embodiment is different from that in the above-described second example embodiment in that an inclination driver is provided. The remaining components and operations are the same as those in the second example embodiment. Hence, the same reference numerals denote the same components and operations, and a detailed description thereof will be omitted.

A three-dimensional laminating and shaping apparatus 700 further includes an inclination driver 701. The inclination driver 701 inclines a base plate 207. For example, the inclination driver 701 inclines the base plate 207 by pivoting the base plate 207 around an axis at the left end of the base plate 207, which extends in a direction perpendicular to the drawing surface of FIG. 7A.

For example, the inclination driver 701 is a device that inclines the base plate 207 (the three-dimensional laminating and shaping apparatus 700) by lifting it from below. Examples of the device are a mechanical jack, a liquid jack, and an air jack, but the device is not limited to them. When the inclination driver like this is provided on the bottom surface at the right end of the base plate 207, it is possible to lift the right end of the base plate 207 and incline the base plate 207. Note that the method of inclining the three-dimensional laminating and shaping apparatus 700 is not limited to the method of lifting from below by using a jack or the like, and may also be, for example, a method of pulling up from above by using a crane or the like. Note also that the inclination can be fixed. An angle of inclination is preferably an angle of 45° or less.

In this example embodiment, a tank cover 741 (the side wall of a shaping tank) is provided in a tank case 742 so as to be opened/closed. In addition, the tank cover 741 is provided in a direction in which a laser beam 221 comes. As shown in FIG. 7B, when the three-dimensional laminating and shaping apparatus 700 is inclined and the tank cover 741 is opened by being flipped up, metal powder particles 214 can directly be irradiated with the laser beam 221. That is, the tank cover 741 is opened when irradiating the metal powder particles 214 with the laser beam 221.

When operating the three-dimensional laminating and shaping apparatus 700 in a horizontal state, the tank cover 741 must be closed in order to prevent a fall of the metal powder particles 214 supplied between the tank cover 741 and a shaping stage 205. That is, the tank cover 741 and the shaping stage 205 must sandwich and press the supplied metal powder particles 214 not to collapse. When the tank cover 741 is closed, the metal powder particles 214 are irradiated with the laser beam 221 which has passed through the tank cover 741 from a light irradiator 202. Since the emitted laser beam 221 decays while the laser beam 221 passes through the tank cover 741 as described above, it becomes impossible to give desired heat (energy) to the metal powder particles 214. Note that in this case, desired heat can be given to the metal powder particles 214 by increasing the irradiation time of the light beam 221, but the shaping time unwantedly increases.

To directly irradiate the metal powder particles 214 with the laser beam 221, the whole three-dimensional laminating and shaping apparatus 700 is inclined, and the tank cover 741 is opened. That is, while collapse of the supplied metal powder particles 214 is prevented by inclining the light irradiator 202 and a shaping tank 203, the metal powder particles 214 are directly irradiated with the laser beam 221 by opening the tank cover 741. In this case, since there is no obstacle between the light emitter 202 and the metal powder particles 214, the metal powder particles 214 can directly be irradiated with the laser beam 221.

Since the three-dimensional laminating and shaping apparatus 700 is inclined, the metal powder particles 214 supplied between the shaping stage 205 and the tank cover 741 move from the high side to the low side (from the upper portion of the inclination to the lower portion of the inclination). This makes it possible to uniformize the bulk density of the metal powder particles 214. Note that the metal powder particles 214 can be supplied in either a state in which the three-dimensional laminating and shaping apparatus 700 is inclined or a state in which it is not inclined.

Furthermore, a controller 208 may adjust the angle of inclination of the three-dimensional laminating and shaping apparatus 700 by the inclination driver 701 and the irradiation time of the laser beam 221 in accordance with a detection result from a supply amount sensor 213.

According to this example embodiment, by inclining the apparatus and opening the tank cover (side wall), it is possible to directly irradiate the metal powder particles with the laser beam, and manufacture a metal laminated and shaped object 210 while laminating the metal powder particles in the lateral direction. Furthermore, since the apparatus is inclined, the supplied metal powder particles do not fall even when the tank cover is opened. In addition, when the apparatus is inclined, the metal powder particles move from the upper portion of the inclination to the lower portion of the inclination, and thus the bulk density of the supplied metal powder particles can be uniformized.

### OTHER EXAMPLE EMBODIMENTS

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

1. A three-dimensional laminating and shaping apparatus comprising:
a shaping stage as a place where a metal laminated and shaped object is shaped;
a moving unit that moves said shaping stage;
a supplier that supplies metal powder particles in a layer on a surface of said shaping stage; and
a light irradiator that irradiates, with a laser beam, powder particles at a predetermined position among the metal powder particles supplied in the layer on the surface of said shaping stages,
said light irradiator including
a laser diode that emits the laser beam, and
an electromechanical mirror that reflects the laser beam and irradiates, with the laser beam, the metal powder particles at the predetermined position among the metal powder particles supplied in the layer on the surface of said shaping stage,
wherein said supplier supplies metal powder particles having a particle size of not more than 50 μm, and
said moving unit moves said shaping stage by one layer in a direction away from said light irradiator in accordance with the particle size.

2. The apparatus according to claim 1, further comprising a shaping tank that accommodates said shaping stage,
wherein the surface of said shaping stage is in a vertical direction or forms a predetermined angle with respect to the vertical direction, and
said supplier supplies the metal powder particles to a gap between the surface and an inner wall surface of said shaping tank.

3. The apparatus according to claim 2, wherein after said supplier supplies the metal powder particles to the gap between the surface and the inner wall surface of said shaping tank before said light irradiator emits the laser beam, said moving unit moves said shaping stage toward the inner wall surface.

4. The apparatus according to claim 1, wherein the metal powder particles contain at least one of copper, nickel, cobalt, molybdenum, titanium, aluminum, and stainless.

5. The apparatus according to claim 1, wherein
said supplier supplies metal powder particles having a particle size of not more than 2.0 μm, and
said moving unit moves said shaping stage by more than 2.0 μm for one layer in a direction away from said light irradiator.

6. The apparatus according to claim 1, further comprising an inclination driver that inclines said shaping tank.

7. A control method of a three-dimensional laminating and shaping apparatus including
a shaping stage as a place where a metal laminated and shaped object is shaped,
a moving unit that moves the shaping stage,
a supplier that supplies metal powder particles in a layer on a surface of the shaping stage, and
a light irradiator that irradiates, with a laser beam, powder particles at a predetermined position among the metal powder particles supplied in the layer on the surface of the shaping stages,
the light irradiator including
a laser diode that emits the laser beam, and
an electromechanical mirror that reflects the laser beam and irradiates, with the laser beam, the metal powder particles at the predetermined position among the metal powder particles supplied in the layer on the surface of the shaping stage,
the method comprising:
causing the supplier to supply metal powder particles having a particle size of not more than 50 μm; and
causing the moving unit to move the shaping stage by one layer in a direction away from the light irradiator in accordance with the particle size.

8. A control program of a three-dimensional laminating and shaping apparatus including
a shaping stage as a place where a metal laminated and shaped object is shaped,
a moving unit that moves the shaping stage,
a supplier that supplies metal powder particles in a layer on a surface of the shaping stage, and
a light irradiator that irradiates, with a laser beam, powder particles at a predetermined position among the metal powder particles supplied in the layer on the surface of the shaping stages,
the light irradiator including
a laser diode that emits the laser beam, and
an electromechanical mirror that reflects the laser beam and irradiates, with the laser beam, the metal powder particles at the predetermined position among the metal powder particles supplied in the layer on the surface of the shaping stage,
the program for causing a computer to execute a method, comprising:
causing the supplier to supply metal powder particles having a particle size of not more than 50 μm; and
causing the moving unit to move the shaping stage by one layer in a direction away from the light irradiator in accordance with the particle size.
